(19) United States
(12) Patent Application Publication
(10) Pub. No.: US 2006/0111986 A1
(43) Pub. Date: May 25, 2006

(54) System, method, and computer program product for automated consolidating and updating of inventory from multiple sellers for access by multiple buyers

(76) Inventors: Kevin S. Yorke, Ashburn, VA (US); R. Seth Trotman, Arlington, TX (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/025,112

(22) Filed: Dec. 30, 2004

Related U.S. Application Data
(60) Provisional application No. 60/629,293, filed on Nov. 19, 2004.

(51) Int. Cl. G06Q 30/00

(52) U.S. Cl. 705/26

(57) ABSTRACT

A system and method that allow for collection of available and sellable goods or services in a real-time or near real-time environment from a network of retail or a chain of retail stores, wholesalers, distributors, or service providers. The collective database is made available to the general public via a network or communications system (e.g., the world wide web, an intranet, a respective virtual private network (VPN), or any other form of electronic transfer) for purchase utilizing best price available for both parties.

### CROSS REFERENCE TO RELATED APPLICATIONS

This application claims priority under 35 U.S.C. § 119(e) to U.S. Provisional Patent Application No. 60/629,293, filed Nov. 19, 2004, entitled “Retail Inventory Consolidation Database Network ‘RICDN’,” to Kevin S. Yorke and R. Seth Trotman, which is incorporated by reference herein in its entirety.

### BACKGROUND OF THE INVENTION

1. Field of the Invention

The present invention is related to automated product and service databasing and synchronization in an e-commerce system.

2. Background Art

Several companies over the past ten years have attempted to create a business-to-consumer sales model that focused on secondhand merchandise, for example, collected in part from the pawn industry in a central database. Each attempt turned out to be unsuccessful. First, each storeowner, or manager, had to manually list and maintain their inventory on the central database. Second, the storeowners were charged a monthly fee to have their merchandise listed on the central database. This latter aspect was undesirable because it required the storeowner to pay a company maintaining the central database a monthly fee to list their products, while also requiring the storeowner to do the work of updating their inventory online, with no assurance of any sales to come.

Therefore, what is needed is a system and method that can link multiple stores or service providers to a central database or a selected central database for access by third party consumers. The system and method can allow for automatic updating of the central database or selected central database, and only require payment when sales of the store's products or service provider's services are made.

### BRIEF SUMMARY OF THE INVENTION

An embodiment of the present invention provides a method comprising the following steps. Generating product or service information at a first node corresponding to a product or service. Transmitting the product or service information to a second node. Generating identification data based on the product or service information. Storing the identification data for access by a third node. Initiating communication between the third node and the first node based on the identification data. Updating the product or service information and the identification data based on the communication.

Another embodiment of the present invention provides a system comprising first and second controllers, a transmitter, and a communication system. The first controller generates product or service information at a first node corresponding to a product or service. The transmitter transmits the product or service information to a second node. The second controller generates identification data based the product or service information and stores the identification data in a database for access by a third node. The communication system is used for communication between the third node and the first node after the third node has access the identification data. The first and second controllers control updating of the product or service information and the identification data based on the communication.

In a further embodiment, the present invention provides a computer program product comprising a computer useable medium having a computer program logic recorded thereon for controlling at least one processor, the computer program logic comprising computer program code devices that perform operations similar to the devices in the above embodiment.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIG. 1 shows a system, according to one embodiment of the present invention.

FIG. 2 shows a portion of a system, according to one embodiment of the present invention.

FIGS. 3, 4, and 5 show flowchart depicting methods, according to various embodiments of the present invention.

FIGS. 6 and 7 show graphical user interfaces, according to various embodiments of the present invention.

FIG. 8 shows a communication, according to one embodiment of the present invention.

FIGS. 9 and 10 show a flowchart depicting various methods, according to various embodiments of the present invention.

FIG. 11 shows an exemplary computer system for implement various operations, according to one embodiment of the present invention.

FIG. 12 is a flowchart depicting a method, according to one embodiment of the present invention.

The present invention will now be described with reference to the accompanying drawings. In the drawings, like reference numbers may indicate identical or functionally similar elements. Additionally, the left-most digit(s) of a reference number may identify the drawing in which the reference number first appears.

### DETAILED DESCRIPTION OF THE INVENTION

Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications than those discussed herein.

Embodiments of the present invention provide a system and method that allow for collection of available and sellable goods or services in a real-time or near real-time environment from a network of retail or a chain of retail stores, wholesalers, distributors, or service providers. The collective database is made available to the general public via a network or communications system (e.g., the world wide web, an intranet, a respective virtual private network (VPN), or any other form of electronic transfer) for purchase utilizing best price available for both parties. Exemplary System

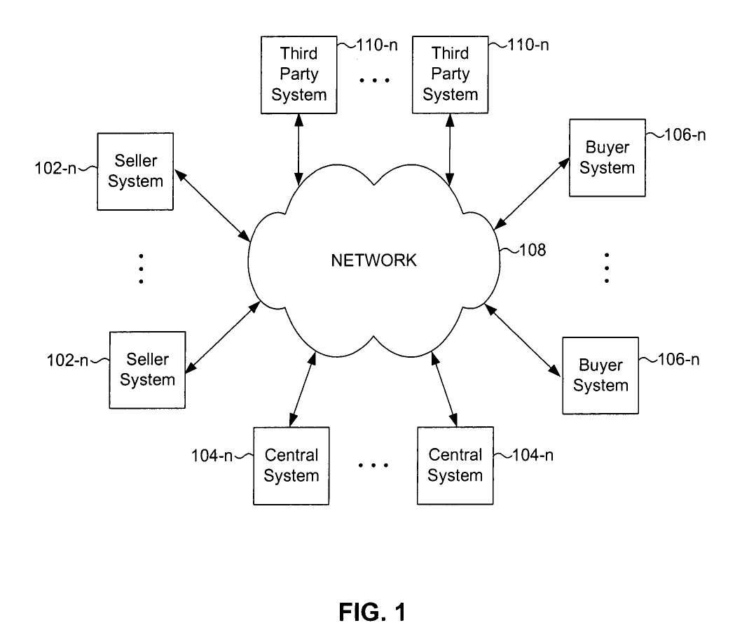

FIG. 1 shows a system 100, according to one embodiment of the present invention. System 100 includes one or more first nodes 102-n (e.g., seller systems) (n is an integer greater than or equal to 1), one or more second nodes 104-n (e.g., central systems), and one or more third nodes 106-n (e.g., buyer systems) all coupled together via a network 108. Network 108 can be a wired or wireless network, for example, but not limited to, the Internet, an intranet, an extranet, a virtual private network, a WAN, a LAN, or the like. In one example, system 100 also includes one or more fourth nodes 110-n (e.g., third party systems), which can be, but are not limited to, retail or auction websites, e.g., EBAY®.

Each of the central systems 104 can be related to a single type of product or a single type of industry (e.g., pawn broking, gun sales, etc.). In the latter example, only a single central system 104 is needed, while in the former example, each type of product needs a central system 104. For example, a type of industry can be, but is not limited to, Pawn Shops, Car Dealerships, Used Video and DVD shops, Used Sporting Goods, Used Computer shops, Gun Stores new and second hand, Consignment Shops, Rental Centers—Tools and Party Supplies, Adult bookstores and Adult Toys, Used and New Camera Stores, Electronic Shops, New and Used Jewelry, Check Cashing Companies, Payday Advance Companies, Used Software Stores, Used and New Music, and/or Comic Book Stores. In one example, each of these would automatically be linked to a specific central system 104 associated with their industry, or each of their products would be automatically linked to a specification central system 104.

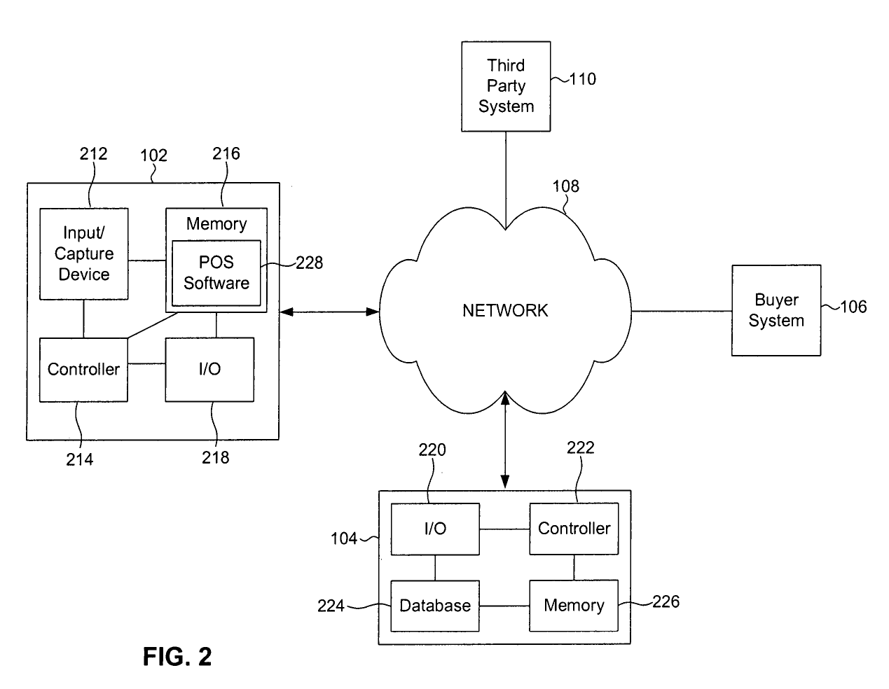

FIG. 2 shows details of a portion of system 100, according to one embodiment of the present invention. Seller system 102 comprises an input/capture device 212, a controller 214, a memory 216, and an input/output (I/O) device 218 coupled to network 110. Central System 104 comprises an input/output device 220, a controller 222, a database 224, and a memory 226. Although shown as separate device, in one example memory 226 and database 224 can be a single, partition memory device.

Although not necessarily shown, one or more nodes can include one or more computer systems, servers, routers, etc. used for communications between nodes, as would become apparent to one of ordinary skill in the art upon reading and understanding this description. These computer systems, servers, routers, etc. can be either positioned locally or remotely from an associated node, as would also be understood.

With reference now to FIGS. 1 and 2, in various examples, seller system 102 can be for a seller of products and/or services, and memory 216 can include software, firmware, or the like (hereinafter referred to as software), for example point-of-sale (POS) software 228 with many different platforms: Microsoft® Access, Microsoft® Visual FoxPro, Microsoft® Visual Basic, Borland® C++ Builder, Visual DataFlex, etc.

In one example, product information is received or captured using input/capture device 212. Then POS software 228, under control of controller 214, gathers and analyzes available inventory for sale based on the product information. The product information is transmitted via network 108 to central system 104. In one example, this is based on an application program interface (API) of a particular central system 104 that is in POS software 228 or associated with POS software 228 in each seller system 102. This API automatically links and/or synchronizes POS software to central system 104 to automatically transmit, receive, and/or synchronize data between the two. In one example, as described above, the API automatically links a seller system 102 to a specific central system 104 associated with its industry and/or to one or more central systems associated with its products.

Central system 104 then generates identification information relating to the product information, under control of controller 222 and possibly a software program stored in memory 226, and stores the identification information in database 224. This identification information in database 224 is then accessible by buyer system 106 via network 108. In one example, the identification information can include a number of the product in database 224, a number of the product in a database maintained at each seller system 102, and product number on seller system 102.

In one example, the product information includes, but is not limited to, make, model, cost, asking price, minimum price, color, condition, missing parts, special features, etc. regarding each product or service. In various examples, either all or sub-product information can be used by buyer system 106. In various examples, this product information is captured via entry from input/capture device 212, which can be a keyboard, touch screen, machine code reader, digital camera, combinations of these devices, or the like. In one example, the product information is just a paragraph of data that needs to be analyzed using a known or proprietary language program to determine the specifics of the product, e.g., make, model, cost, asking price, minimum price, color, condition, missing parts, special features, etc. This language program can be a learning (AI) language program that increases its knowledge through each use.

In either case, in one example (e.g., a two-way communication example) once the product information is received at central system 104, a picture or similar information related to a generic product is forward to seller system 102 to verify this is the correct product. If verified, the identification information is generated and stored. In another example (e.g., a one way communication example), only seller systems 102 communicate to central system 104, and other than reporting back the unique item identifier code, no further information is passed to seller system 102.

In one example, identification information includes the product information and unique ID code associated with this information, which allows each seller system 102 to remain anonymous with respect to each buyer system 106. Thus, in this example, only central system 104 will know both an identity of a seller and a buyer until a transaction is complete.

In one example, a category of the products and/or the seller associated with a particular seller system 102 can also be transmitted to database 224. This category can be either based on a governmental established code system or a code system established by each individual central system 104. For either case, a look-up table can be saved in memory 226 or accessed via network 108 from one of the third party systems 110. In one example, in order to determine a proper category, a user of seller system 102 is asked or prompted to answer a series of questions or enter general information. This data is analyzed automatically either using POS software 228 and/or at central system 104 to determine one or more categories that can be associated with the data. In various examples, the user is either then told a category or suggested one or more categories.

In one example, when two-way communications are being used, central system 104 can generate a list of one or more categories based on historical data regarding previous categories assigned certain industries or products stored in memory 226 or database 224, e.g., a generator is used in Florida during hurricane season or in the mountains by campers and hikers, as entered by previous seller systems 102. Then, the user can choose which category to list their products or services.

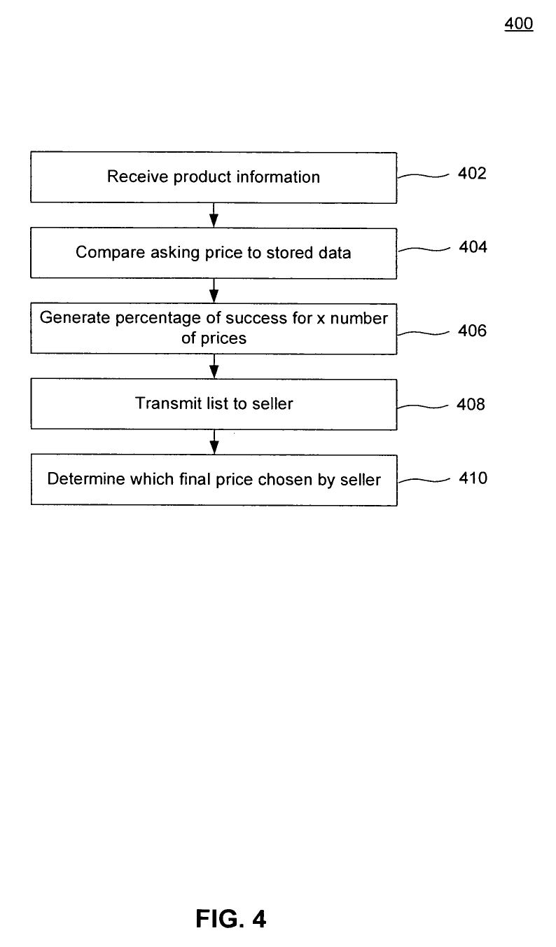

In one example, once central system 104 receives the product information from seller system 102, central system 104 automatically compares an asking price in the product information against other asking prices and/or previously sold prices in database 224 and generates a communication to seller system 102 including one or more suggestions (see FIG. 4 below). For example, central system 104 can determine a probability of success of sale for various prices of the product in the product information based on historical data in database 224 and/or memory 226 and send this information to seller system 102. Seller system 102 can then ignore or use this data to adjust/update the product information. In various examples, the historical data can be national data, regional data, or location specific data. In one case, the pricing metric can be automatically given to seller system 102 by central system 104, while in another case the pricing metrics are required to be requested specifically by seller system 102.

In one example, when two-way communications are being used, central system 104 can receive or access changes in product status from a manufacturer and alert seller system(s) 102 of this change. For example, the information can be gathered from third party system 110 or via other means. In various examples, this information can relate to make and model number changes, new generations being released, defective product recalls, changes in suggested retail prices, termination of product lines, etc. This will allow seller system 102 to update the product information accordingly. In one example, the change in status of the product information can come from one or more seller systems 102. For example, in the pawn industry a change of status will be classified as a sale, a buy, a pawn, a layaway, a change in description, a change of pricing or a change of the number of a specific inventory quantity. Any inventory change in POS software 228 at each seller system 102 is updated to the database automatically available online so that the inventory is updated in near real-time or real-time. In either case, seller and central systems 102 and 104 are updated accordingly, e.g., synchronized.

In one example, the present invention is related to the collection and maintaining of available and sellable goods or services in a real-time or near real time environment from a network of retail or a chain of retail stores, wholesalers, distributors, or service providers. The information relating to the goods or services are stored in a collective, relational, etc. database 224 that is accessible to the general public via network 108. The collection and maintaining are performed via POS software 228 being linked, using an API, to central system 104.

In one example, all communications and/or data transactions between seller system 102 and central system 104 use 128-bit, or higher, encryption. Although in another example, other encryptions methods can also be used, or if the seller wishes, none at all.

In one example, each seller system 102 is logged on and synchronized with database 224 periodically for a predetermined time period, for example once an hour for 30 seconds, or more periodically as needed for synchronization purposes. This is near real time. In other examples, real time is used for synchronization, e.g., immediately during and after every transaction.

In one example, an initial and subsequent transmission of information from each seller system 102 to central system 104 is based on entering a correct user name and password given to authorized seller systems 102. In another example, username/passwords are required with evry access to the API. There is no logging on and logging off, per se. Each API function call requires a valid username/password that has permission to access information in a given store.

In one example, when a seller system 102 ends a session with central system 104, predetermined information is automatically cleared from memory 224, or the like, on central system 104. This prevents other systems coupled to network 108 from viewing data that was displayed during a transfer session.

In one example, the API is a set of database calls that allows the API enabled software program 228 to directly talk to central system 104. The API by itself does nothing, but when implemented by POS software 228 it allows the basic functions needed to have seller system 102 send its inventory to central system 104 automatically. It can provide a method to update those items online as their information changes at the store level. It can provide a means of alerting the store that an offer has been made on a piece of merchandise listed, and even can allow for direct negotiations with a web user from within POS software 228, if desired by a seller system 102. However, in one example all communications between seller system 102 and the API are initialized by seller system 102.

Simple changes in item information within seller system 102 might include, but are not limited to: new inventory that was purchased and received into the pawnshop; changes to an item's status if that item was sold, put on layaway, re-pawned, or charged-off during an audit. Each of these changes would result in a call to the API to make the same change online. Additionally, when a customer makes on offer online, the API can notify the software, allowing seller system 102 to accept an offer to sell an item, decline that same offer, or make a counter-offer to the customer interested in purchasing the merchandise. Additional features include direct auction placements to an auction site (e.g., a third party system 110) on network 108 through the API.

In one example, central system 104 supplies a stock image and description, usually from the manufacturer, for a particular product description. In other example, each seller system 102 records a picture and links it to the product description. The image database is maintained and updated through new product description, accessing manufacture's systems, and/or through accessing other websites through searches that have similar products. This stock image can also be used to verify the correct product information was entered by seller system 102.

In one example, central system 104 can push down updates to either the API or POS software 224 during synchronization.

Exemplary Initial Operation

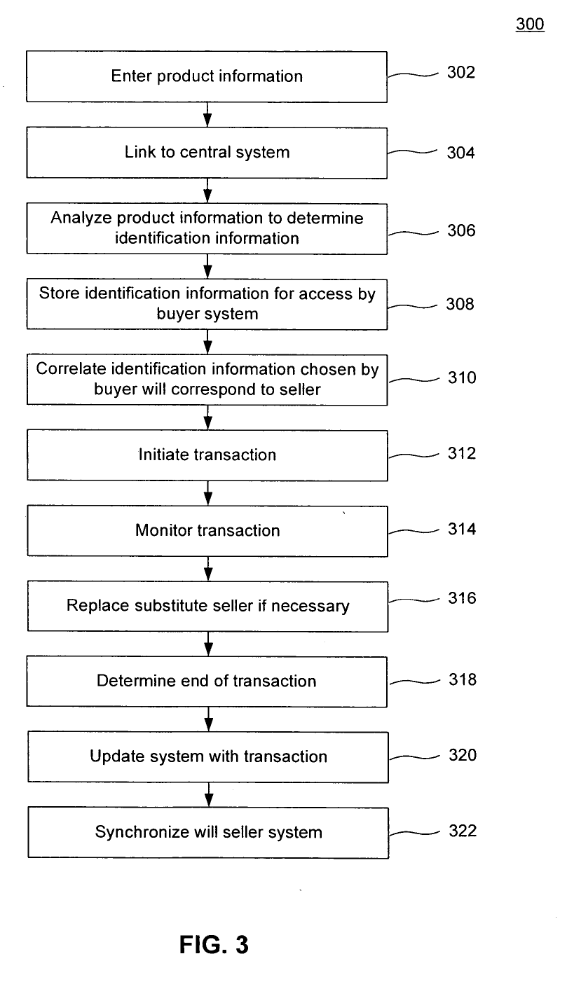

FIG. 3 shows a flow chart depicting a method 300, according to one embodiment of the present invention. For example, this method describes enrolling, inventory build, and an overview of a transaction. This method can automatically be performed using system 100, for example. In step 302, a seller system receives product information. In step 304, the product information is transmitted to a central system. In step 306, the central system analyzes the product information to generate identification information. This can include, as described above, determining at least make, model, condition, cost, minimum price, and asking price. This can also include any uniqueness associated with the product. In one example, the seller system is asked whether the product information is correct based on forwarding a standard picture and/or standard information as obtained previously or through a manufacturer. In another example, the seller system is requested to verify an asking price to be used based on a statistical analysis of previously sold items percentage of selling at various prices. Once finally verified, in step 308 the identification information is stored in the central system, which can now be accessed by either all buyer systems or by buyer systems in an associate program, described below.

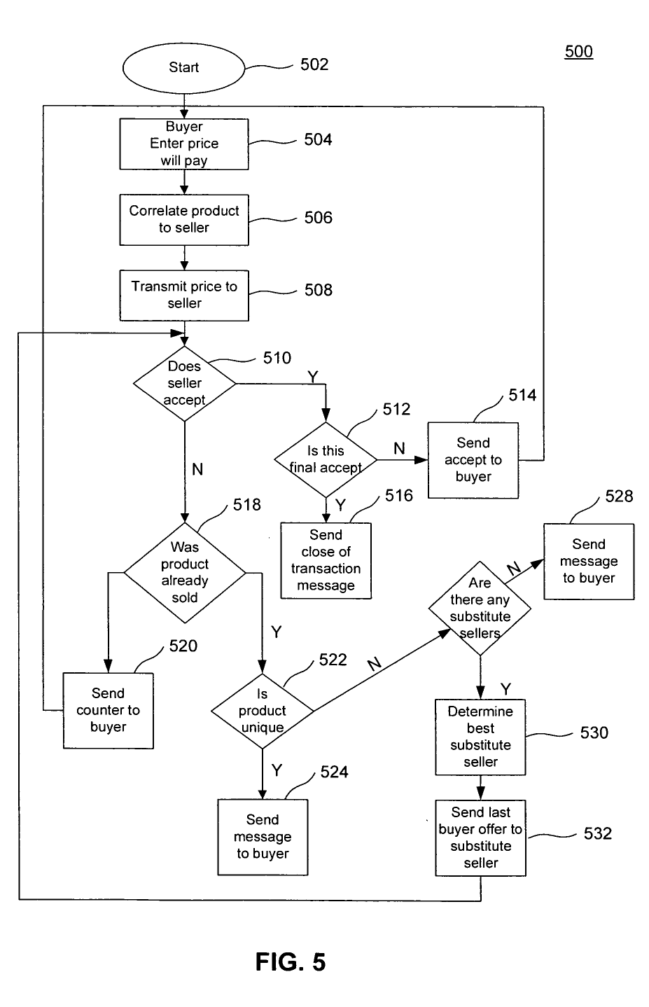

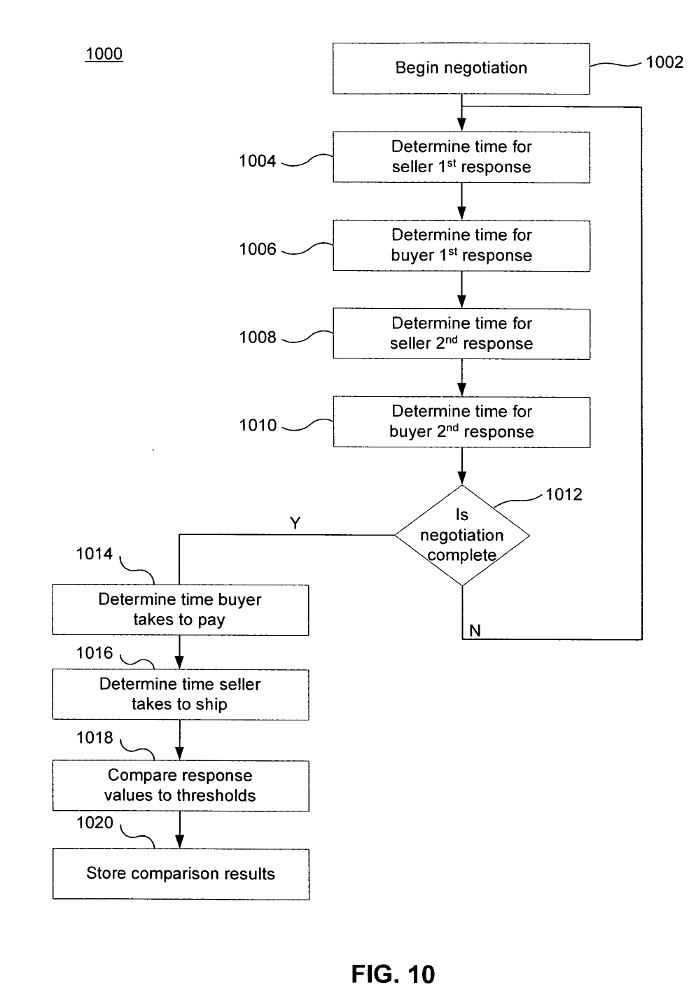

In step 310, after a buyer system has accessed the product information associated with stored identification information and made an offer on the corresponding product, the central system correlates the identification information with the seller system. In step 312, the central system initiates a transaction, which is described in more detail below with respect to FIG. 5. In step 314, the central system monitors the transaction for quality and to determine whether the central system needs to take additional steps during the transaction. For example, in step 316 the central system can determine that a substitute seller needs to become inserted into the transaction, as described in more detail below with respect to FIG. 5. In short, if an initial seller has sold the item to another buyer, and the item is not unique, a substitute seller is determined and inserted into the transaction. In step 318, the central system determines whether the transaction has completed. In step 320, the central system updates the database and memory with transaction information. For example, this can include information used to determine ratings of the buyer and seller (see FIG. 10), information relating to a final price, information relating to removing the identification information form the central system, or the like. Some of these operations are described in more detail below. In step 322, if not already done, the central system synchronizes with the seller system to finalize all updates from the transaction.

FIG. 4 shows a flowchart depicting a method 400, according to one embodiment of the present invention. For example, this method is used to determine a best selling price for each product. This method can be performed by system 100, for example. In step 402, product information is received at a central system from a seller system. In step 404, the asking price is compared to stored data. For example, the stored data can be historical data and/or newly accessed data from third party systems or other means. In one example, this can be based on one or more of national, international, regional, etc. prices previously accepted by other buyers on the central system. In step 406, a determination is made from this comparison what a percentage of success of selling the product will be at one or more prices. In one example, a list of these percentages and prices is generated. In step 408, if requested or allowed by a seller system, the list is forward to the seller system. In step 410, a final determination is made for final prices selected by the seller system. This final price is stored in the identification information. In other words, in one example a list of these percentages and prices is generated and forwarded to the seller system. If a seller's final determination for pricing differs from their initial listing of the item, a change request is issued to alter the price to correspond with that final determination.

Exemplary Transaction Operation

FIG. 5 shows a flowchart depicting a method 500, according to one embodiment of the present invention. For example, this describes a transaction between a buyer and a seller. This method can be performed by system 100, for example. In step 502, a transaction is initiated or started, e.g., a buyer chooses a product from a central system that they wish to purchase. In step 504, the buyer enters a price they are willing to pay for the product. In step 506, the product is correlated to a seller using a central system. In step 508, the buyer's price is transmitted to the seller anonymously, e.g., via email, instant messaging, cell phone call or text messaging, or otherwise over a network (hereinafter, only email is discussed for brevity). For example, it can be an anonymous transaction because only user names, user ids, etc. are displayed in any communication between a seller and a buyer. In step 510, a determination is made whether the seller accepts the buyer's price.

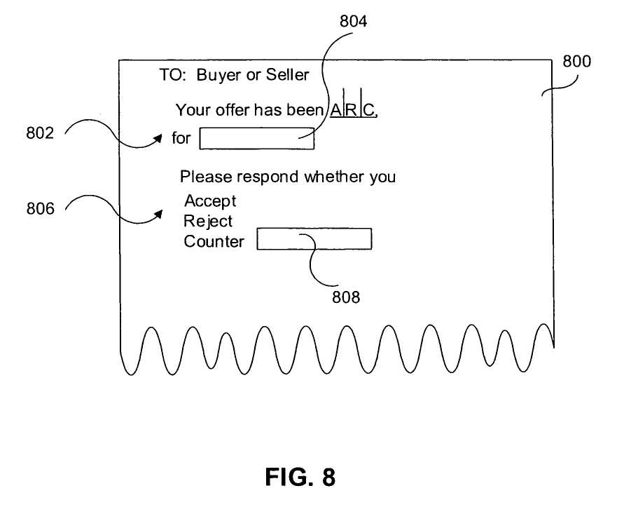

If the price is accepted by the seller in step 510, in step 512 a determination is made whether this is a final acceptance of the seller. In this operation, a seller must accept twice because of the use of real time inventory. If no, in step 514 a first communication is sent to the buyer, e.g., via email (see FIG. 8) or via the other means discussed above. In one example, the communications between the buyer and seller from this point on indicate acceptance, rejection, or a counteroffer and a price associated therewith. Then method 500 repeats steps 502-512. When it is determined a final acceptance has been made by the seller, in step 516 a close of transaction message is sent to the buyer, e.g., via email. After receiving this message, the buyer is asked to submit payment information so the seller can initiate shipping of the product.

If the price is not accepted by the seller in step 510, in step 518 a determination is made whether the product has been sold already by the seller. For example, a person may have walked into a pawn shop and purchased the item. If no, the seller may make a counteroffer, in which case in step 520 a counteroffer communication is transmitted to the buyer, e.g., via email as discussed above, indicating a counteroffer and message associated therewith, and method 500 returns to step 502.

If an answer to step 518 is yes, in step 522 a determination is made whether the product is unique. This can be determined based on the product information initially forward from a seller system 102 to a central system 104. For example, the buyer may have initiated the transaction to purchase a green and blue game machine, and not just a game machine, and for some reason the buyer only wanted the green and blue game machine. If yes (i.e., the product is unique), in step 524 a message is sent, e.g., via email, to the buyer that the product is no longer available.

If no to step 522 (i.e., the product is not unique), in step 526 the central system determines if a substitute seller having an equivalent product for sale exists. If no, in step 528 a message is sent to the buyer that the product is no longer available. If yes at step 526, in step 530 a list of substitute sellers is analyzed to determine a best substitute seller. For example, this can be based on a seller having a most similar item and/or on a seller having a highest rating (see FIG. 10 below) and a substantially similar item, as is discussed below. Once a best substitute seller is determined by the central system, in step 532 the buyer's offer is sent to the substitute seller. Then, method 500 returns to step 510.

In another exemplary operation of system 100, buyer system 106 accesses database 224 via network 108, e.g., via a website of central system 104. Once buyer system 106 finds a product or service of interest, it communicates, e.g., via email, with a seller system 102 associated with the product or service, but only known to central system 104. The first communication is then viewed at seller system 102 and a second communication, e.g., via email, is generated and forwarded to buyer system 106. If buyer system 106 accepts the second communication, a third communication is transmitted, e.g., via email, to seller system 102. These communications represent offers, acceptances, rejections, and counteroffers to buy or sell the product or service of interest. Finally, if seller system 102 accepts the third communication, a fourth communication is transmitted, e.g., via email to buyer system 106. It is to be appreciated that more communications may be necessary during negotiation. In one example, the communications are via email, or the like. The responses to each communication can be acceptance, rejection, counteroffer, or the like.

As discussed above, in one example, a seller system 102 may have already sold the product or service during the communication (e.g., a pawn shop in which another buyer walked in and bought the product). In this case, central system 104 detects the sale through the removal of the product information associated with the identification information buyer system 106 is using. Then, central system 104 determines a next best match of a substantially similar product from another seller system 102 and transmits the last communication from buyer system 104 to new seller system 102 to continue negotiations. This can only be done if the product or service is generic, and not unique. In one example, buyer system 106 would not be aware of this change in seller system 102.

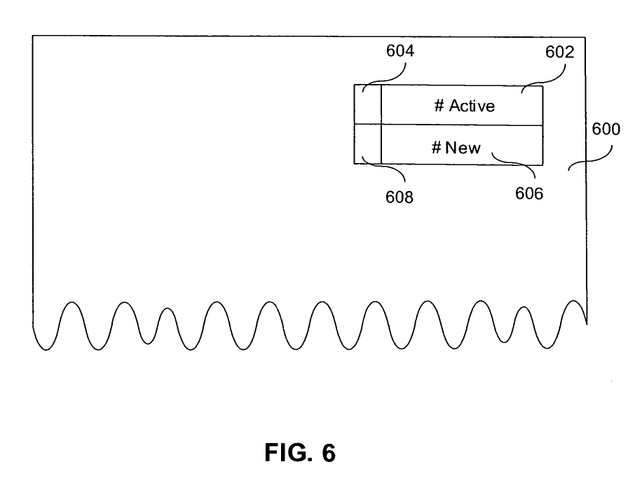

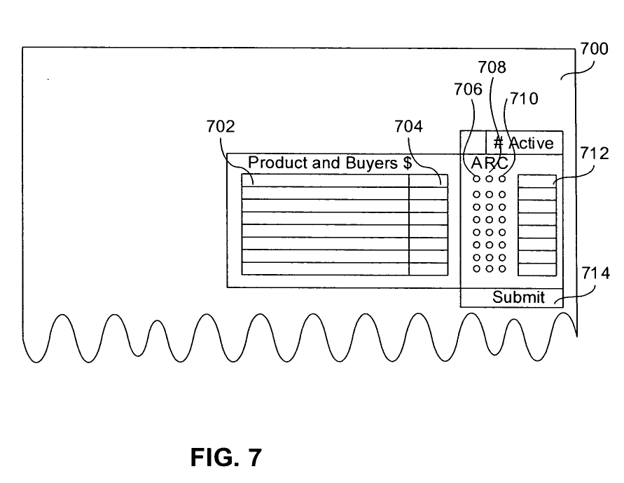

FIG. 6 shows an exemplary graphical user interface 600 seen by a seller system 102, according to one embodiment of the present invention. Typically, this interface 600 is seen during one or more transactions with one or more buyers. Interface 600 includes an area 602 including a number of active negotiations and a command region 604 adjacent thereto, which allows a user to see more information related to the active negotiations (see FIG. 7). In one example, interface 600 also includes an area 606 including a number of new negotiations and a command region 608, which allows the user to see more information relating to the new negotiations.

FIG. 7 shows an exemplary graphical user interface 700 seen by a seller system, according to one embodiment of the present invention. Typically, interface 700 is seen after the user has activated command region 604. Interface 700 includes information relating to active negotiations. In one example, this includes product ID number of the seller 702, a buyer's most recent offer 704, command regions allowing acceptance (A) 706, rejection (R) 708, or counteroffers (C) 710, a space for a counteroffer price 712 and a submit command region 714. Interface 700 also shows interface 600, from which it was expanded. In this interface 700, a seller can easily monitor and update all active negotiations, and easily respond to all buyers in one submit operation. For example, a seller simply clicks A, R, or C and fills in a price for all active negotiations at one time, then hits submit 714 to send a communication to all buyers at once.

FIG. 8 shows an exemplary communication 800, according to one embodiment of the present invention. In one example, when a seller uses an interface 600 and/or 700, this communication 800 is communicated to a buyer. Communication 800 includes a region 802 including information directed to a rejection, acceptance, or counteroffer of a seller and a current price 804 the seller is willing to accept. Communication 800 also includes a region 806 asking the buyer for more information, for example whether they accept, reject, or want to counteroffer the seller's latest price. If a counteroffer is selected, a price is entered in region 808. This price is what is displayed in region 704 in interface 700. In another example, when a seller does not use interfaces 600 and 700, but performs the negotiation via email, the seller would also receive this email message 800 with the buyer's latest information, which the seller can accept, reject, or counter. In this case, region 808 can be used for a price accepted or countered, which is based on which command region or link is chosen in region 806.

Once negotiations are completed and buyer system 106 has accepted a final offer from seller system 102, buyer system 106 is directed to a payment portion of central system 104, e.g., PAYPAL® or the like. When payment is accepted and approved, sellers system 102 is notified and, when its product sale, a shipping invoice is prepared for the product to the seller via an accepted shipping company.

After completion of the transaction, a percentage of the sale or profit margin from the same is automatically posted to an accounts payable file in memory 226 of central system 104 for each seller system 102, and seller system 102 is billed periodically for using central system 104. In one example, this percentage can be seller system based, industry based, or any other criteria can be used. In another example, the percentage can be fixed across all sellers and industries.

In one example, at the end of a predetermined period either established by a seller system 102 or central system 104, a statistical analysis of seller system 102 is performed. For example, time from posting to sale is determined for all products or products in certain categories. Also, any other desired marketing analysis of a buyer system 102 operations on central system 104 can be generated and forward to a buyer system 102 at any time interval.

In one example, buyer systems 106 can establish predetermined products or other criteria to be used for alerts from central system 104. This can be determined through online or hardcopy customer surveys or during enrollment of individual buyer systems 106.

In one example, buyer systems 106 can establish that only seller systems 102 within a certain geographical regions are desired for speed of delivery of the product to the buyer system location. Exemplary Additional Category of Buyer Systems

In one embodiment, a sub-set of buyer systems 106 is determined based on an enrollment procedure with central system 104. This sub-set of buyer systems 106 can have access to new identification data recently added to database 224 before buyer systems 106 outside of the sub-set.

In one example, each member of the sub-set establishes one or more categories of products they are interested in knowing about. Central system 104 generates and forwards a list of the products, for example, based on all products, new products, or based on profit margin for re-sale. In the latter example, in one example central system 104 accesses information from one or more third party systems 110 to determine a current price for similar products on third party system 110 or uses hardcopies of databases with statistical data for sales of similar products elsewhere. Then, central system 104 compares the current selling prices to prices for either newly added products in database 224 or all similar products in database 224, and generates a list of which products meet a threshold profit margin established by each sub-set buyer system 106. This list is then forward to the individual sub-set buyer systems 106.

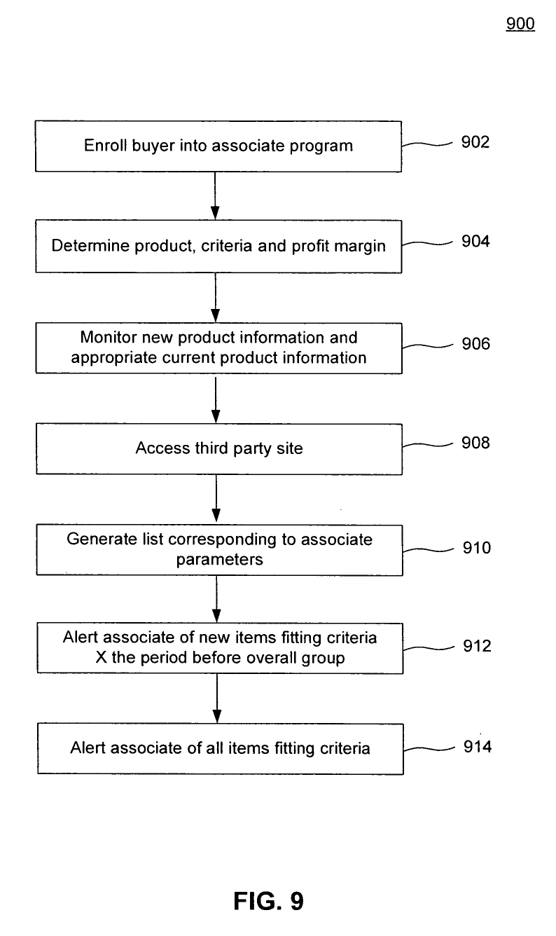

FIG. 9 shows a flowchart depicting a method 900, according to one embodiment of the present invention. For example, this method describes enrolling and list generation for an associate product of a sub-set of buyer systems 106. This method can be performed using system 100, for example. In step 902, a buyer is enrolled in an associate buyer program. In one example, this associate program, for a fee, allows certain rights to the enrollee, for example, first viewing of new products or access to individually generated product lists prepared by a central system. In step 904, product criteria for each enrollee is determined. In one example, a profit margin is determined for acceptable products between a seller's price and a price on a resale third party system. In step 906, new product information received by the central system and/or current product information entered in the central system is monitored by the central system. In step 908, this new or current information is used to generate a search of third party systems. In step 910, a list is generated that correlates the new or current products to associated parameters of each enrollee. In step 912, the enrollee is alerted of new products that fit the criteria of the enrollee. In one example, this alert is forwarded to the enrollee before all other non-enrollee buyers can see the information. In step 914, the enrollee is alerted of all current products that fit the criteria of the enrollee.

Exemplary Ratings Systems

In one embodiment, each individual seller system 102 and buyer system 104 is assigned a rating in central system 104.

For example, a rating for each seller system 102 is based on at least one of: (1) how close a seller is to real-time updating of product information in database 224 after transactions have completed and/or after change in status of products are determined; (2) how quickly a seller enters shipping invoices for products after a transaction is completed and/or how quickly the product is shipped; and/or (3) customer feedback of accurateness of description of product compared to actual product received, condition of product received, easiness of negotiations with the seller, number or gravity of detrimental reviews of the seller by one or more buyers, etc. For criteria (1) and (2), a seller can either be compared to preset threshold levels of response times or to historical data stored in memory 226 or database 224 relating to response times of similar sellers for similar products.

In one example, seller ratings are posted next to products on a website of central system 104. In another example, seller ratings are used during a negotiation process when one seller has already sold a product being used in the negotiation so another seller needs to be substituted for the original seller, as described above. In the example described above, the seller with a substantially similar product and a highest rating will be a first seller chosen by central system 104 to take over negotiation with a buyer.

For ratings of buyers, criteria can be based on one or more of: (1) how quickly the buyer responds to communications from the seller during negotiation and/or (2) how quickly the buyer pays the seller after negotiations have ended.

In one example, buyer systems 106 can tailor negotiations with only seller systems 102 having a particular rating. Similarly, seller systems 102 can only negotiate with buyer systems 106 having a particular rating.

FIG. 10 shows a flowchart depicting a method 1000, according to one embodiment of the present invention. For example, this method describes time period measuring, storage, and comparing to determine ratings of buyers and sellers. This method can be performed using system 100, for example. In step 1002, a negotiation is initiated, e.g., a buyer chooses a product and initiates communicates an acceptable price to the seller to purchase the product. In step 1004, a time period of a seller's first response to a buyer's price is measured (e.g., after receiving a first inquiry from a buyer, how fast the seller sends back an answer). In step 1006, a time period of a buyer's first response to the seller's first response is measured (e.g., an email sent to the seller with an acceptance, rejection, or counteroffer to the seller's counteroffer). In step 1008, a time period of the seller's second response to the buyer's first response is measured (e.g., a second acceptance, rejection, or counteroffer communication sent to the buyer). In step 1010, a time period of the buyer's third response to the seller's second response is measured. In step 1012, a determination is made whether the negotiation is complete. If no, method 1000 continues with another set of first and second response times being measured. If yes to step 1012, in step 1014 how long it takes the buyer to pay the seller is measured. In step 1016, how long it takes the seller to ship to the buyer after the seller pays is measured. In step 1018, each measured time period is compared to a respective threshold value. In step 1020, results of the comparisons are stored. In one example, the stored results are used to rank or assign ratings to buyers and sellers, for example, from most preferred to least preferred. This rating can be used when determining a substitute seller, as is discussed above, or to select which of a number of enrollee buyers (described above) to first inform of the availability of a product of interest.

Exemplary Computer System

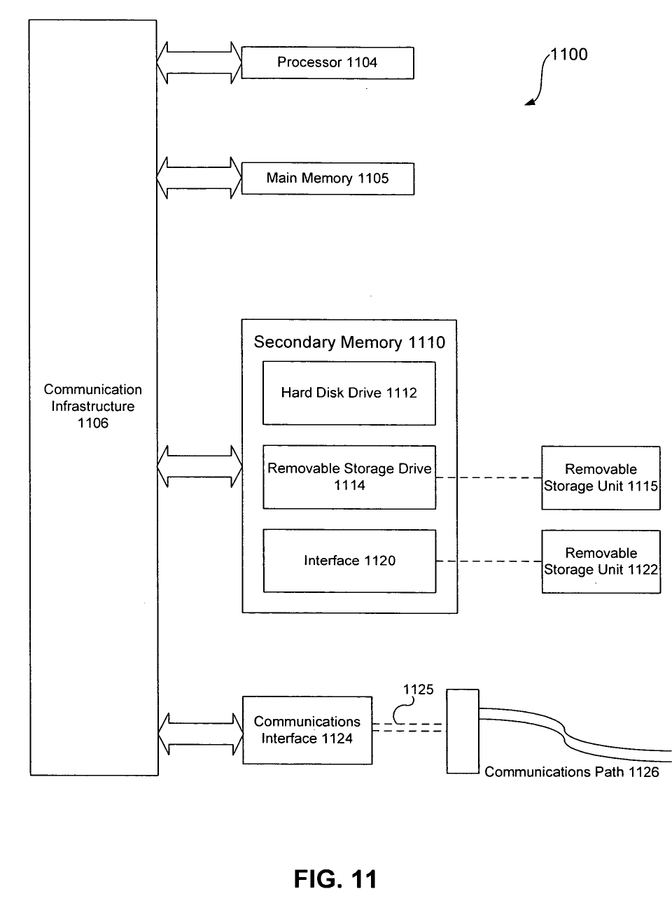

FIG. 11 illustrates one or more processors, such as processor 1104. Processor 1104 can be a special purpose or a general purpose digital signal processor. The processor 1104 is connected to a communications infrastructure 1106 (for example, a bus or network). Various software implementations are described in terms of this exemplary computer system. After reading this description, it will become apparent to a person skilled in the relevant art how to implement the invention using other computer systems and/or computer architectures.

Computer system 1100 also includes a main memory 1108, preferably random access memory (RAM), and may also include a secondary memory 1110. The secondary memory 1110 may include, for example, a hard disk drive 1112 and/or a removable storage drive 1114, representing a floppy disk drive, a magnetic tape drive, an optical disk drive, etc. The removable storage drive 1114 reads from and/or writes to a removable storage unit 1118 in a well known manner. Removable storage unit 1118, represents a floppy disk, magnetic tape, optical disk, etc. which is read by and written to by removable storage drive 1114. As will be appreciated, the removable storage unit 1118 includes a computer usable storage medium having stored therein computer software and/or data.

In alternative implementations, secondary memory 1110 may include other similar means for allowing computer programs or other instructions to be loaded into computer system 1100. Such means may include, for example, a removable storage unit 1122 and an interface 1120. Examples of such means may include a program cartridge and cartridge interface (such as that found in video game devices), a removable memory chip (such as an EPROM, or PROM) and associated socket, and other removable storage units 1122 and interfaces 1120 which allow software and data to be transferred from the removable storage unit 1122 to computer system 1100.

Computer system 1100 may also include a communications interface 1124. Communications interface 1124 allows software and data to be transferred between computer system 1100 and external devices. Examples of communications interface 1124 may include a modem, a network interface (such as an Ethernet card), a communications port, a PCMCIA slot and card, wired or wireless systems, etc. Software and data transferred via communications interface 1124 are in the form of signals 1128 which may be electronic, electromagnetic, optical or other signals capable of being received by communications interface 1124. These signals 1128 are provided to communications interface 1124 via a communications path 1126. Communications path 1126 carries signals 1128 and may be implemented using wire or cable, fiber optics, a phone line, a cellular phone link, an RF link and other communications channels.

In this document, the terms “computer program medium” and “computer usable medium” are used to generally refer to media such as removable storage drive 1114, a hard disk installed in hard disk drive 1112, and signals 1128. These computer program products are means for providing software to computer system 1100.

Computer programs (also called computer control logic) are stored in main memory 1108 and/or secondary memory 1110. Computer programs may also be received via communications interface 1124. Such computer programs, when executed, enable the computer system 1100 to implement the present invention as discussed herein. In particular, the computer programs, when executed, enable the processor 1104 to implement the processes of the present invention, such as the method(s) implemented by seller system 102, central system 104, buyer system 106, third party system 110, etc., as described above. These processes may be performed automatically, of invoice some form of manual intervention. Accordingly, such computer programs represent controllers of the computer system 1100. Where the invention is implemented using software, the software may be stored in a computer program product and loaded into computer system 1100 using removable storage drive 1114, hard drive 1112 or communications interface 1124.

The invention is also directed to computer products (also called computer program products) comprising software stored on any computer useable medium. Such software, when executed in one or more data processing device, causes the data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.). It is to be appreciated that the embodiments described herein can be implemented using software, hardware, firmware, or combinations thereof.

Exemplary Overall Methodology

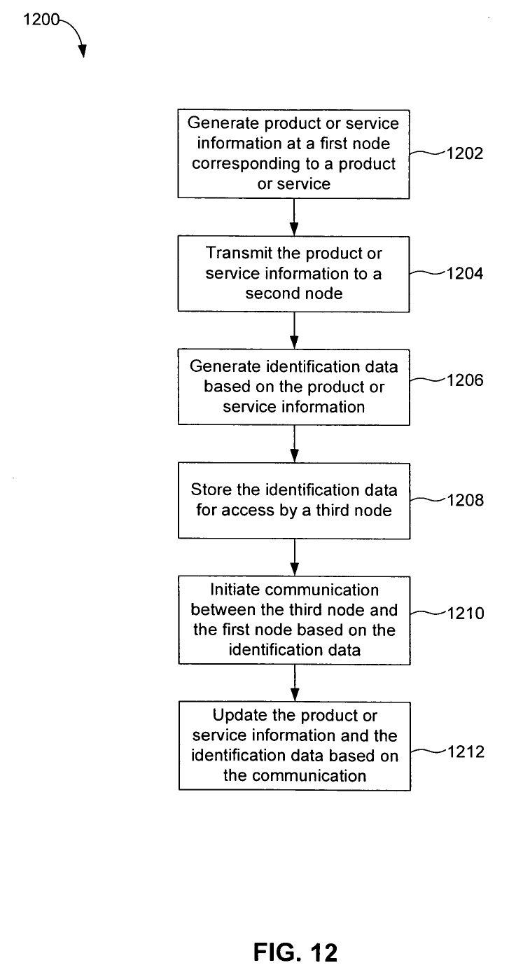

FIG. 12 shows a flowchart depicting a method 1200, according to one embodiment of the present invention. In one example, method 1200 is performed in one or more of the above systems described in FIGS. 1, 2, and/or 3. In step 1202, product or service information is generated at a first node (e.g., a seller system) corresponding to a product or service. In step 1204, the product or service information is transmitted to a second node (e.g., a central system). In step 1206, identification data is generated based on the product or service information. In step 1208, the identification data is stored for access by a third node (e.g., a buyer system). In step 1210, communication between the third node and the first node is initiated using the identification data. In step 1212, the product or service information and the identification data is updated based on the communication.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A method, comprising:
(a) generating product or service information at a first node corresponding to a product or service;
(b) transmitting the product or service information to a second node;
(c) generating identification data based on the product or service information;
(d) storing the identification data for access by a third node;
(e) initiating communication between the third node and the first node using the identification data; and
(f) updating the product or service information and the identification data based on the communication.

2. The method of claim 1, wherein step (a) comprises:
looking-up the category code in a look-up table.

3. The method of claim 1, wherein step (a) comprises:
transmitting the product or service information to the second node;
comparing the transmitted product or service information to previously stored product or service information;
generating the category code from the comparing step; and
transmitting the category code to the first node.

4. The method of claim 3, wherein:
the generating step comprises generating more than one category code;
the transmitting step transmits the more than one category code to the first node; and
the first node determines a best-match category code from the more than one category code.

5. The method of claim 1, wherein step (c) comprises:
separating predetermined portions of the product or service information into sub-product or service information that is used to generate the identification data.

6. The method of claim 5, wherein the sub-product or service information in the identification data is separately accessible by the third node.

7. The method of claim 5, wherein the separating step comprises:
analyzing the product or service information using a language tool to determine the sub-product or service information.

8. The method of claim 7, wherein the separating step further comprises:
analyzing the product or service information using at least one of historical data and statistical data stored in the second node to determine the sub-product or service information.

9. The method of claim 1, wherein the receiving step in step (a) comprises one of:
inputting data via an input device; or
capturing data via a capture device.

10. The method of claim 1, wherein step (f) further comprises:
detecting a manufactures change in status of the product or service; and
updating of the product or service information and the identification information based on the change in status of the product or service.

11. The method of claim 1, further comprising:
(g) generating one or more values correlating to the product or service at the second node; and
(h) transmitting the one or more values to the first node.

12. The method of claim 11, wherein step (g) comprises:
using a location of the first node to perform the generating step.

13. The method of claim 1, further comprising:
(g) analyzing transaction information for all of the product or service information transmitted by the first node.

14. The method of claim 13, wherein step (g) comprises:
determining a length of time before updating of the identification data from the second node based the first node removing the identification data for one or more product or services.

15. The method of claim 1, wherein step (e) comprises:
(e1) a first communication from the third node to the first node;
(e2) a second communication from the first node to the third node;
(e3) a third communication from the third node to the first node; and
(e4) a fourth communication from the first node to the third node.

16. The method of claim 15, wherein if the product or service information is removed by the first node before step (e4), then the second node transmits the third communication to a fourth node that has transmitted substantially similar product or service information to the second node as the product or service information accessed by the second node.

17. The method of claim 15, further comprising:
(g) determining a first time period between steps (e1) and (e2);
(h) determining a second time period between steps (e3) and (e4);
(i) comparing the first and second time period to a threshold value; and
(j) generating a rating value of the first node based on step (i), wherein the second node utilizes the rating value during subsequent transactions between the first node and one or more of the third nodes.

18. The method of claim 15, further comprising:
(g) determining a time period between steps (e2) and (e3);
(h) comparing the time period to a threshold value; and
(i) generating a rating value of the third node based on step (h), wherein the second node utilizes the rating value during subsequent transactions between the third node and one or more of the first nodes.

19. The method of claim 15, further comprising:
(e5) a fifth communication including transmitting of financial information from the third node to the first node; and
(e6) a sixth communication including transmitting of the product or service from a location of the first node to a location of the third node.

20. The method of claim 19, further comprising:
(g) determining a time period between step (e5) and (e6);
(h) comparing the time period to a threshold value; and
(i) generating a rating value of the first node based on step (h), wherein the second node utilizes the rating value during subsequent transactions between the first node and one or more of the third nodes.

21. The method of claim 19, further comprising:
(g) determining a time period between step (e4) and (e5);
(h) comparing the time period to a threshold value; and
(i) generating a rating value of the third node based on step (h), wherein the second node utilizes the rating value during subsequent transactions between the third node and one or more of the first nodes.

22. The method of claim 1, before step (e) further comprising:
establishing a sub-set of a plurality of the third nodes; and
allowing the sub-set of the third nodes to have access to the identification data before the plurality of the third nodes.

23. The method of claim 22, further comprising:
determining a difference value between a price value in the identification data and a price value on a fourth node;
comparing the difference value to a threshold value; and
generating a data set including the identification information related to the difference values that are above the threshold value that is only accessible by the sub-set of third nodes.

24. The method of claim 1, wherein step (b) further comprises:
correlating a category code to the product or service information; and
determining a second node from a plurality of second nodes that corresponds to the category code before the transmitting step.

25. The method of claim 24, wherein step (c) comprises:
generating the identification data based on at least one of the product or service information and the category code.

26. The method of claim 1, wherein step (f) further comprises:
detecting when the first node changes a status of the product or service; and
updating of the product or service information and the identification information based on the change in status of the product or service.

27. A system, comprising:
a first controller that generates product or service information at a first node corresponding to a product or service;
a transmitter that transmits the product or service information to a second node;
a second controller that generates identification data based the product or service information and stores the identification data in a database for access by a third node; and
a communication system that is used for communication between the third node and the first node after the third node has access the identification data, wherein the first and second controllers control updating of the product or service information and the identification data based on the communication.

28. A computer program product or service comprising a computer useable medium having a computer program logic recorded thereon for controlling at least one processor, the computer program logic comprising:
computer program code means for generating product or service information at a first node corresponding to a product or service;
computer program code means for transmitting the product or service information to a second node;
computer program code means for generating identification data based on the product or service information;
computer program code means for storing the identification data for access by a third node;
computer program code means for initiating communication between the third node and the first node using the identification data; and
computer program code means for updating the product or service information and the identification data based on the communication.

29. A system, comprising:
means for generating product or service information at a first node corresponding to a product or service;
means for transmitting the product or service information to a second node;
means for generating identification data based on the product or service information;
means for storing the identification data for access by a third node;
means for initiating communication between the third node and the first node using the identification data; and
means for updating the product or service information and the identification data based on the communication.
